(19) United States
(12) Patent Application Publication
(10) Pub. No.: US 2002/0147679 A1
(43) Pub. Date: Oct. 10, 2002

(54) Credit card driver's license

(76) Inventor: Ronald L. Tardif, Fairfax Station, VA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/827,247

(22) Filed: Apr. 6, 2001

(51) Int. Cl. G06F 17/60

(52) U.S. Cl. 705/39

(57) ABSTRACT

A system and method for obtaining driver's license credit card products is disclosed. Applicants who visit a Department of Motor Vehicles (DMV) facility to obtain a driver's license may be offered the opportunity to obtain a line of credit that is associated with their driver's license. After applicants provide credit information, the DMV facility generates credit validation requests that are sent to a credit card issuer. The credit card issuer determines whether the applicant is eligible to receive a line of credit based on information included in the credit validation requests. The credit card issuer generates credit validation responses based on the determination and sends the response back to the DMV facility. The DMV facility determines whether the applicants were each approved for a line of credit from the credit card issuer, and if so, generates a driver's license credit card product that may be used as a license to operate a motor vehicle and as a standard credit card.

### FIELD OF THE INVENTION

This invention relates to credit card products and to systems and methods for providing and using such products. More particularly, the invention relates to systems and methods for merging credit card products with driver's licenses to create multi-purpose card products that function both as a driver's license and a credit card.

### BACKGROUND AND MATERIAL INFORMATION

Picture identification cards have traditionally been recognized as the standard item used for authenticating an individual's identity in face-to-face transactions. Whether it is for cashing personal checks, purchasing selected goods (such as alcoholic beverages) or applying for credit credits, an individual generally must present some form of certified identification before such transactions are completed. There are a number of different types of identification cards that are deemed acceptable by the public and government agencies that are used to validate a person's identity. Of these, the most popular is arguably the State driver's license.

State driver's licenses are generally applied for and obtained at a State's Department of Motor Vehicles (DMV) office. At a DMV office, an applicant usually presents information that authenticates their identity (i.e., a previous driver's license, social security card, etc.). Once authenticated, the applicant may fill out an application that includes information associated with the license, such as current address and donor status. After successfully completing any appropriate tests required by the State in which the applicant resides (i.e., eye examinations, driver's tests, etc.), the applicant is photographed and a new driver's license is generated. Following the payment of an appropriate fee, the applicant is then issued the new license.

Along with driver's licenses, another popular card product that is generally carried by individuals is credit cards. Credit card products have become so universally well known and ubiquitous that they have fundamentally changed the manner in which financial transactions and dealings are viewed and conducted in society today. Credit card products are most commonly represented by plastic card-like members that are offered and provided to customers through credit card issuers (such as banks and other financial institutions). With a credit card, an authorized customer or cardholder is capable of purchasing services and/or merchandise without an immediate, direct exchange of cash. With each purchase, the cardholder incurs debt to their credit card account, which the cardholder may thereafter pay upon receipt of a monthly or otherwise periodic statement. In most cases, the cardholder will have the option to either fully pay the outstanding balance or, as a matter of necessity or choice, defer at least a portion or the balance for later payment with accompanying interest or finance charges for the period during which payment of the outstanding debt is deferred (also referred to as a revolving charge credit line).

The spending power of a credit card (i.e., the maximum amount of finds that is financed to the cardholder for making purchases) is typically limited to a particular amount that is predetermined by the issuer of the card. This amount is commonly referred to as the “credit limit” of the credit card. The credit limit provides the cardholder with a line of credit (also referred to as a credit line). The size of the issuer-imposed credit limit is generally based on a number of non-exclusive factors, the most important of which are often the cardholder's earning capacity and the cardholder's credit history. When purchases are made or debts incurred with the credit card, the available portion of the credit limit is reduced by the purchase or debt amounts. In addition, interest and/or finance charges are also subtracted from the available portion of the credit limit on a periodic basis. The total debits on a credit card are referred to as the “outstanding balance,” while the remaining or available balance of the credit limit is typically called the “available balance” and reflects the dynamically adjusted current spending power of the credit card. The cardholder may increase the available balance up to the credit limit, by paying the outstanding balance to the issuer.

Credit card issuers usually provide general purpose credit cards that may be used for a plurality of different goods and services and with a wide variety of merchants. For example, Visa, MasterCard and American Express, are examples of general purpose credit cards.

In some instances, goods and services cannot be purchased, even with general purpose credit cards, unless the card holder also shows some other form of identification. Generally, a driver's license is used to satisfy this requirement. One problem with purchasing goods or services that require additional identification is that not only does an individual have to carry an identification card, but also some form of purchasing power as well, such as cash or a credit card. For instance, a person planning on visiting a beach, and purchasing alcoholic beverages—which may require a form of identification—must decide to carry not only an identification card, but also some form of spending power, such as cash, checks or credit cards. This can be cumbersome to the individual, especially when the only apparel worn at the beach may be a bathing suit.

Accordingly, there is a need for reducing the number of card products used for identification and purchase purposes that individuals need to carry at one time. There is also a need to provide a multi-function identification credit card product that may be obtained in an efficient manner.

### SUMMARY OF THE INVENTION

Methods, systems and articles of manufacture consistent with the principles of the present invention enable credit card issuers to offer customers (or non-customers) the option of obtaining a line of credit while applying for a driver's license.

Consistent with the principles of the invention, a credit card issuer validates an applicant's credit application while waiting at a DMV office for a new driver's license. Once validation processes are completed, the credit card issuer sends a response message back to the DMV office. If the applicant is approved by the credit card issuer, the DMV office generates a driver's license that is operable as a standard driver's license associated with the activities for driving motor vehicles and a general purpose credit card product issued from the credit card issuer.

Methods, systems and articles of manufacture consistent with the principles of the present invention enable individuals applying for a driver's license at a DMV office to obtain not only a driver's license but also a general-purpose credit card, without having to wait for a new credit card to be received in the mail. Furthermore, methods, systems and articles of manufacture consistent with the present invention enable individuals to obtain a multi-purpose card product that is operable as a standard driver's license and credit card from a DMV office.

Consistent with the principles of the invention, an applicant that has been approved by the credit card issuer to obtain a multi-purpose credit car driver's license from the DMV office may use the multi-purpose card to pay for the fees associated with obtaining the driver's license at the DMV office. Furthermore, the multi-purpose card product may be used by the approved applicant to purchase goods and services immediately after receiving the card product from the DMV office.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description..

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIGS. 1A and 1B illustrate exemplary system environments in which the features and principles of the present invention may be implemented;

FIGS. 2A and 2B illustrate an exemplary main DMV site in which the features and principles of the present invention may be implemented;

FIGS. 2C and 2D illustrate an exemplary local DMV site in which the features and principles of the present invention may be implemented;

FIG. 3 illustrates an exemplary credit card issuer environment in which the features and principles of the present invention may be implemented;

FIG. 4 is an exemplary flowchart for requesting and approving a credit card driver's license, in accordance with the present invention;

FIG. 5 is an exemplary flowchart for performing credit approvals at a local DMV site, in accordance with the present invention;

FIG. 6 is an exemplary flowchart for performing credit approvals at a main DMV site, in accordance with the present invention;

FIG. 7 is an exemplary flowchart for performing credit approvals at a credit card issuer, in accordance with the present invention; and

FIG. 8 is an exemplary flowchart for generating a driver's license credit card product, in accordance with the present invention.

### DESCRIPTION OF THE EMBODIMENTS

Reference will now be made in detail to the invention, examples of which are illustrated in the accompanying drawings. Wherever possible, the same reference numbers will be used throughout the drawings to refer to the same or like parts.

Generally, the present invention is directed to a system and method for providing a multi-purpose credit card product. In accordance with one embodiment of the present invention, applicants at a DMV office are presented with offers for obtaining a general purpose line of credit from a credit card issuer. These offers may be presented through conventional solicitation techniques, as well as while the DMV office is processing an application for a driver's license associated with the applicant. The general purpose credit line may be provided to permit purchases for a variety of goods and/or services from merchants that accept the general purpose credit line.

Methods and systems consistent with the principles of the present invention permit an applicant at a DMV office to obtain a multi-purpose credit card without waiting for a newly issued card to be provided through conventional techniques, such as the mail. Once an applicant has been approved to receive a credit line from a credit card issuer, the DMV office may generate a multi-purpose card product that operates both as a driver's license and a credit card. Therefore, the applicant may carry only a single card product that can be used both as a general credit card and as a standard driver's license.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques. Furthermore, the term credit card or credit card product includes credit cards, debit cards, charge cards and any other type of card product that is associated with financial transactions.

The present invention also relates to computer readable media that include program instruction or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

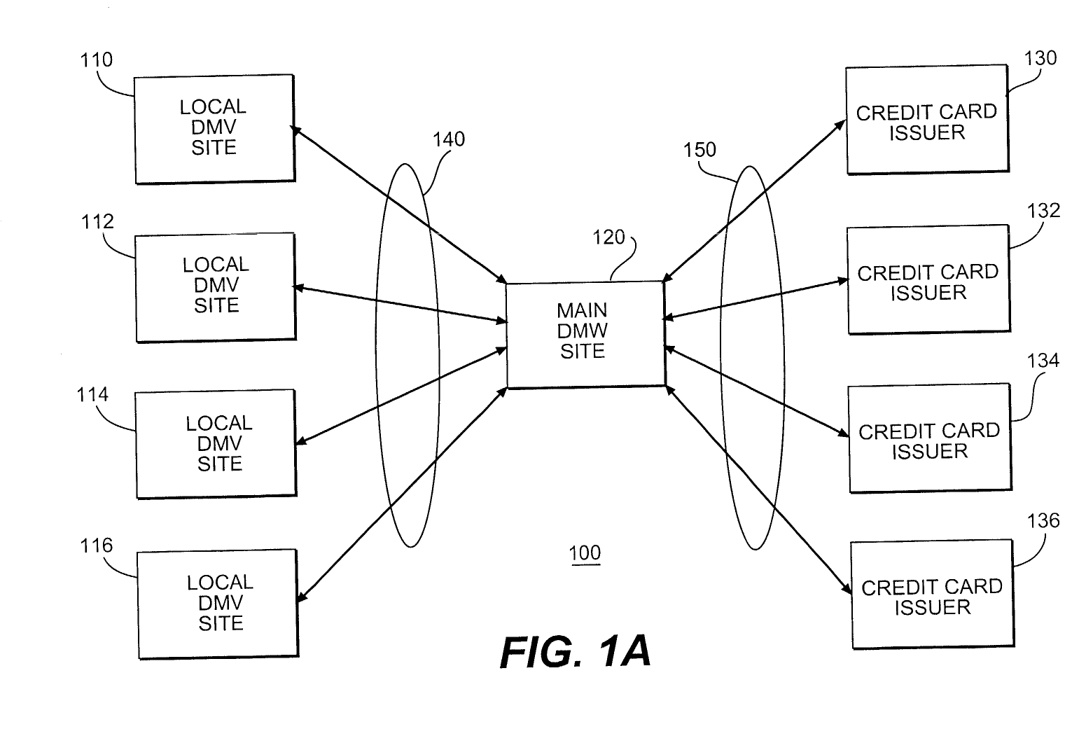

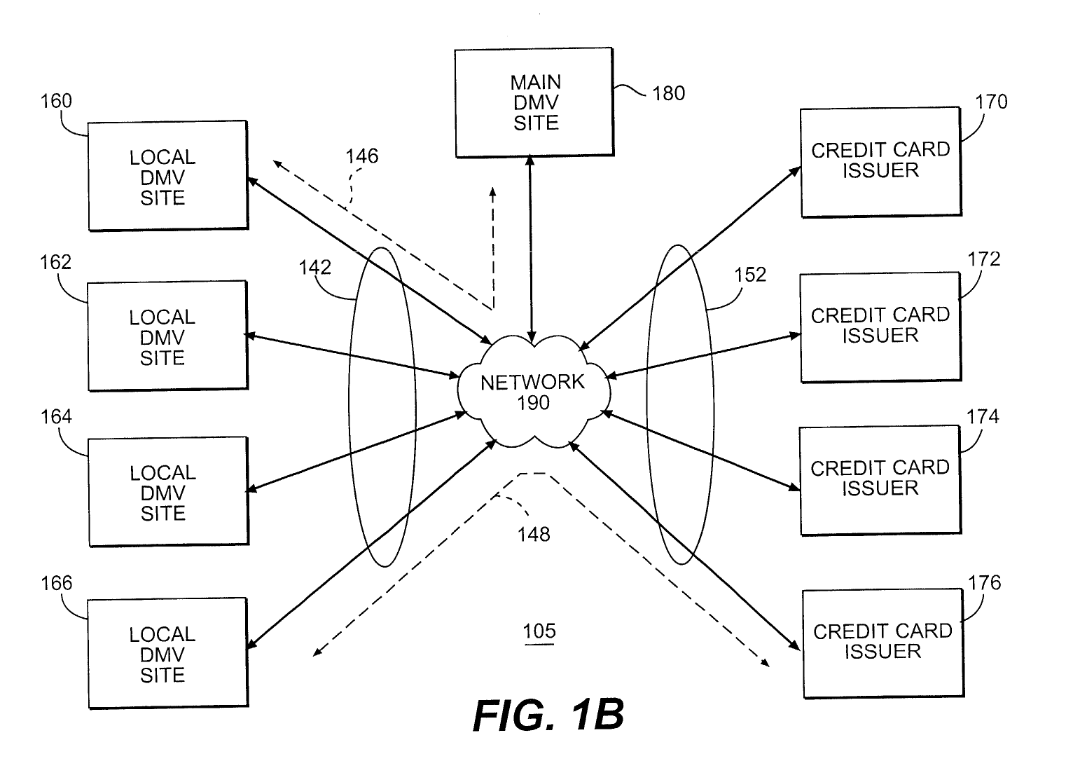

FIG. 1A illustrates an exemplary system environment 100 in which the features and principles of the invention may be implemented. As illustrated in FIG. 1A, the system environment 100 includes a plurality of local DMV sites (110-116), a main DMV site 120, a plurality of credit card issuers (130-136) and communication channels 140 and 150.

Each local DMV site (110-116) in system environment 100 is associated with a different DMV office located within a particular State. Main DMV site 120 is associated with a central office that exchanges information with the local DMV sites through communications channel 140. For instance, local DMV site 110 may be located in the county of Fairfax in the State of Virginia, while local DMV site 112 may be located in the county of Stafford, also in the State of Virginia. Main DMV site 120 may be located in Richmond, Va. and exchanges information with the local DMV offices located in Fairfax and Stafford counties. Further, although FIG. 1A only illustrates only four local DMV sites (110-116), it is of course possible that more or less than four local DMV sites may be provided within system environment 100.

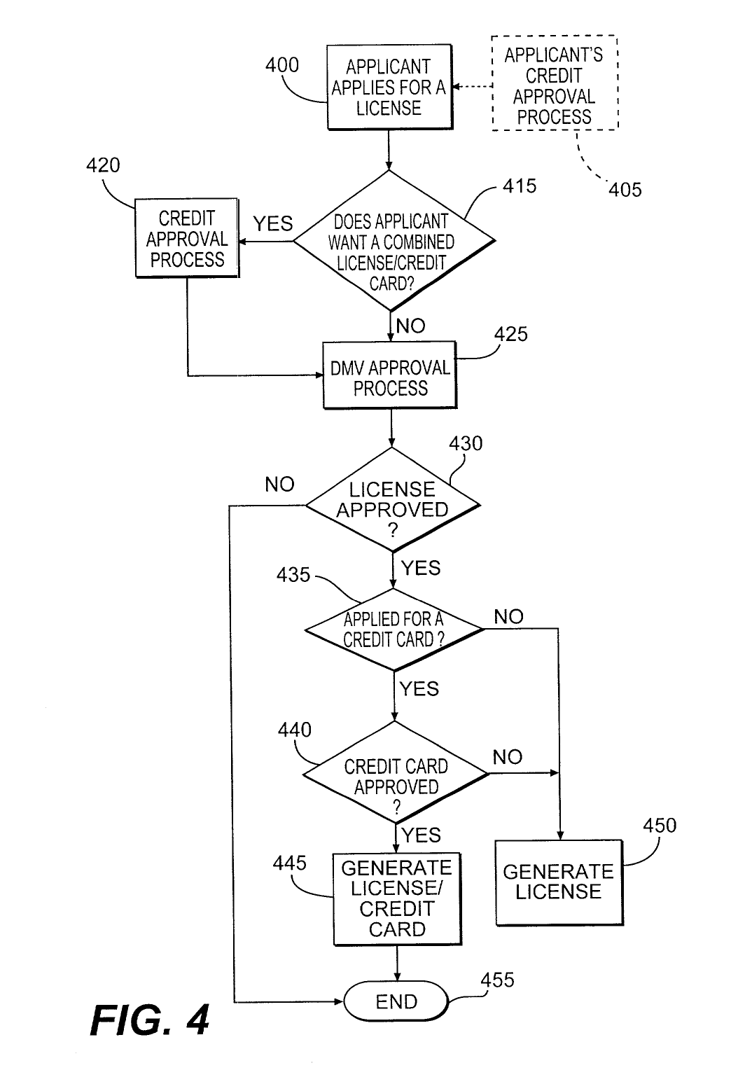

Applicants who wish to apply for a driver's license may visit a local DMV site usually located near their own place of residence. At a local DMV site, for example site 110, an applicant may be instructed to fill out selected personal information . Before a local DMV site will issue a driver's license to an applicant, their identity must be verified. This is usually done by the applicant providing some form of identification that the DMV site will accept as authentic. Such accepted forms of identification may include social security cards or a currently held driver's license. Once the applicant's identity has been confirmed, the applicant may be required to take selected tests depending upon the type of license being requested and the requirements of the State in which the DMV office represents. In accordance with features and principals of the present invention, the applicants may be queried for credit information as well. Details of the above described process will be described later with reference to FIGS. 4-7.

Main DMV site 120 represents the central node from which all local DMV offices in the State communicate with. Main DMV site 120 may include a central database of all driver's registered in the State where the main DMV site sits, and their corresponding driving records. This may include, among other things, tickets and or fines that have been issued to a particular registered driver. Main DMV site 120 receives and processes requests from the local DMV offices (110-116) for information associated with applicants that are requesting driver's licenses at the local DMV sites. These requests may be associated with, but are not limited to, driver history, motor vehicle registration information and personal credit validity. According to features and principals of the present invention, main DMV site 120 may aggregate the credit validity requests and periodically forward the requests to an appropriate credit card issuer (130-136) based on applicant information appended to the validity requests. Main DMV site 120 may also receive credit validation responses from credit card issuers (130-136). DMV site 120 may collect, process and forward the responses to the appropriate local DMV site (110-116) where the corresponding requests originated. The process of forwarding and processing credit validation requests and responses will be described further with respect to FIGS. 4-7. Further, although FIG. 1A only illustrates only one main DMV site 120, it is of course possible that more than one main DMV site may be provided in system environment 100.

Communication channel 140 facilitates communications between the various local DMV sites (110-116) and main DMV site 120 illustrated in FIG. 1A. Communication channel 150 facilitates communications between main DMV site 120 and credit card issuers (130-136), as illustrated in FIG. 1. Communications channels 140 and 150 may each include, for example, a telephony-based network, a local area network (LAN), a wide area network (WAN), a dedicated intranet, the Internet, and/or a wireless network. Further, any suitable combination of wired and/or wireless components and systems may be incorporated into communications channels 140 and 150. Any suitable combination of point-to-point communications or networked communications may also be incorporated into communication channels 140 and 150 to facilitate communication between the different entities illustrated in FIG.. 1A. Moreover, any part of communication channels 140 and 150 may be implemented through traditional infrastructures or channels of trade, to permit operations associated with exchanging information the entities illustrated in FIG. 1A to be performed manually or in-person by the various entities illustrated in FIG. 1A.

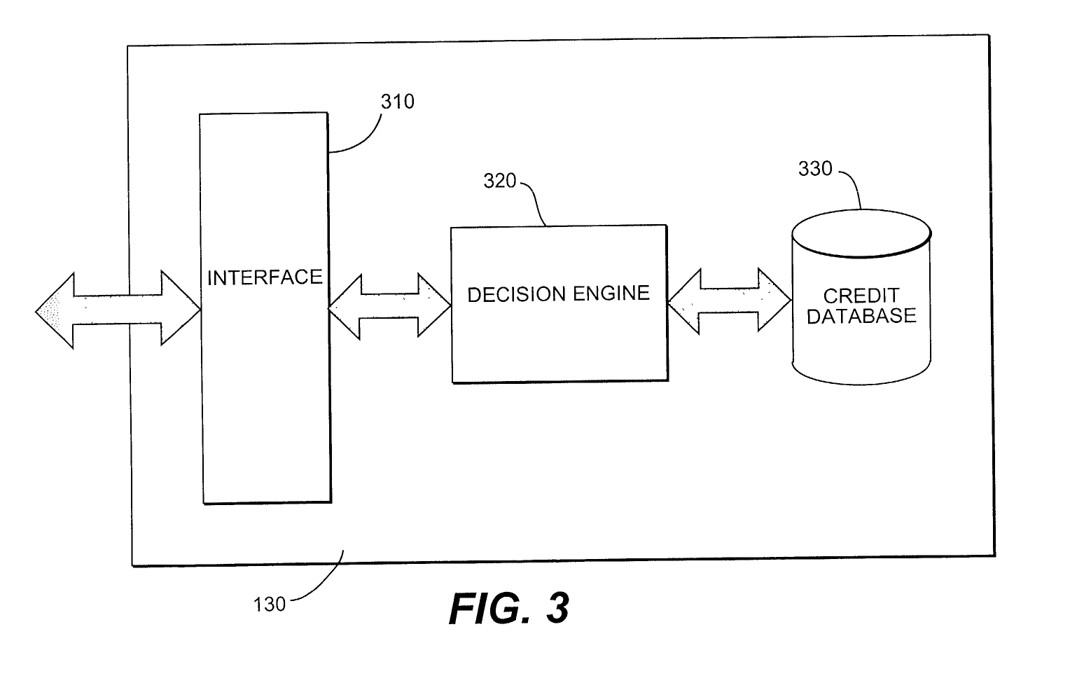

Credit card issuers (130-136) receive credit validation requests from main DMV office 120 and process the requests using a central database (not shown). Upon determining whether an applicant is eligible for a line of credit, a credit card issuer will generate and send a credit validation response message back to main DMV site 120. Credit card issuers (130-136) may be any entity, governmental or non-governmental, associated with granting a line of credit. The credit card issuers (130-136) will be described in further detail with respect to FIG. 3. Furthermore, although FIG. 1A only illustrates only four credit card issuers (130-136), it is of course possible that more or less than four credit card issuers may be provided in system environment 100.

FIG. 1B illustrates another configuration of system environment 100 shown in FIG. 1A. As illustrated in FIG. 1B, system environment 105 includes local DMV sites (160-166), credit card issuers (170-176), main DMV site 180, network 190 and communications channels 142 and 152.

Local DMV sites (160-166) operate similarly to the local DMV sites (110-116) shown in FIG. 1A. Local DMV sites (160-166) may send requests through network 190 to main DMV site 180 for information associated with an applicant's driver history or vehicle. For example, as illustrated in FIG. 1B, local DMV site 160 may send a driver information request 146 to main DMV site 180. Main DMV site 180 processes the request (i.e., collects relevant driver information) and sends a result message 146 back to local DMV site 110.

System environment 105 differs from environment 100 because instead of utilizing main DMV site 180 to facilitate the credit validation requests, local DMV sites (160-166) may send validation requests directly to credit card issuers (170-176) through network 190. Local DMV sites (160-166) also receive validation responses from the credit card issuers (170-176) and processes the received information according to principals of the present invention. FIG. 1B shows a communication path 148 associated with a credit validation request and response between local DMV site 166 and credit card issuer 176.

Main DMV site 180 operates similar to site 120 illustrated in FIG. 1A, with the exception of processing credit validation requests. Credit card issuers (170-176) operate in a manner similar to the credit card issuers (130-136) shown in FIG. 1A, with the exception that the validation result messages are sent directly to the local DMV sites (160-166) and not main DMV site 180.

Communication channel 142 facilitates communications between the various local DMV sites (160-166) and network 190. Communication channel 152 facilitates communications between credit card issuers (170-176) and network 190. As illustrated in FIG. 1B, network 190 facilitates communications between local DMV sites (160-166), main DMV site 180 and credit card issuers (170-176). Communications channels 142, 152 and network 190 may each include, for example, a telephony-based network, a local area network (LAN), a wide area network (WAN), a dedicated intranet, the Internet, and/or a wireless network. Further, any suitable combination of wired and/or wireless components and systems may be incorporated into communications channels 142, 152 and network 190. Any suitable combination of point-to-point communications or networked communications may also be incorporated into communication channels 142, 152 and network 190 to facilitate communication between the different entities illustrated in FIG. 1B. Moreover, any part of communication channels 142, 152 and network 190 may be implemented through traditional infrastructures or channels of trade, to permit operations associated with exchanging information the entities illustrated in FIG. 1B to be performed manually or in-person by the various entities illustrated in FIG. 1B.

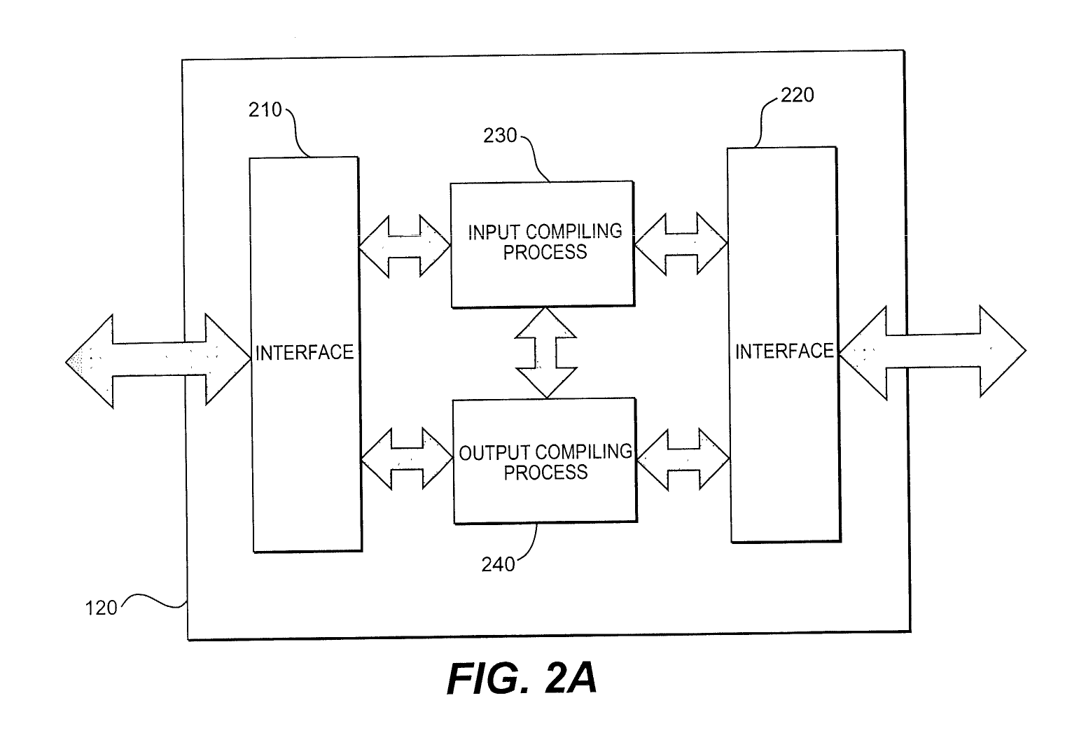

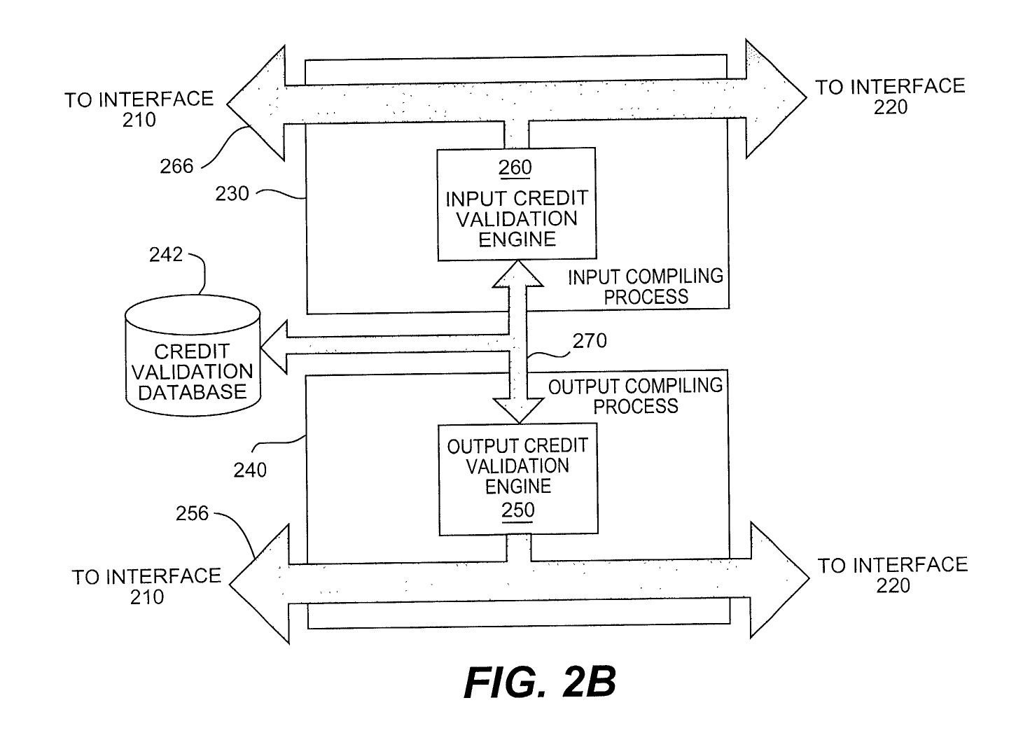

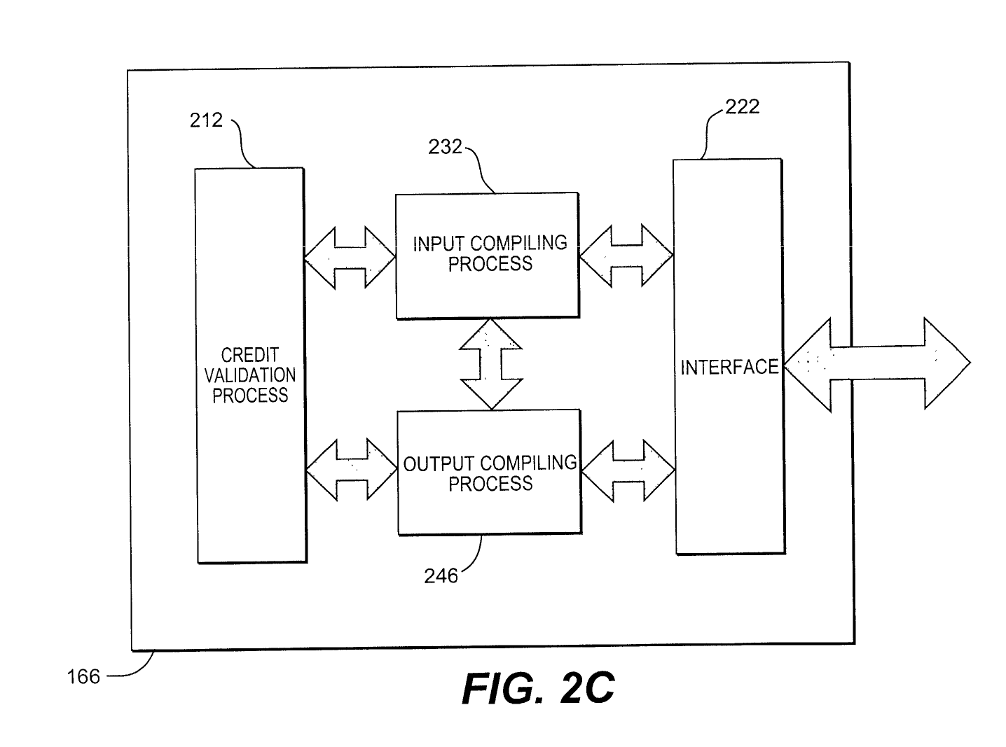

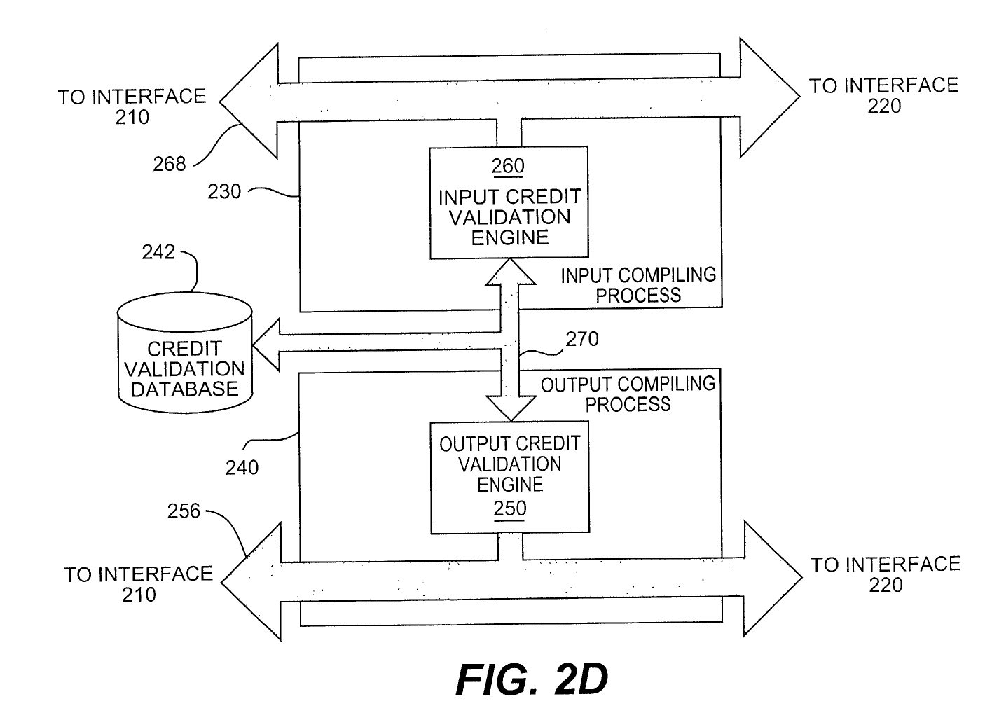

FIG. 2A illustrates an exemplary block diagram of main DMV site 120 which the features and principles of the invention shown in system environment 100 may be implemented. As illustrated in FIG. 2A, main DMV site 120 includes interfaces 210 and 220, input compiling process 230 and output compiling process 240. It should be noted that main DMV site 120 may include elements and processes that are not shown that perform standard day to day DMV operations. The entities illustrated in FIG. 2 show an exemplary configuration that enable main DMV site 120 to perform operations associated with features and principles of the present invention, as will be described below.

Referring to FIG. 2A, interface 210 interconnects communications channel 140 with main DMV site 120. Interface 210 may be a standard network interface that enables information to be communicated between main DMV site 120 and local DMV site (110-116) via communications channel 140. Interface 220, also may be a standard network interface that enables information to be sent from main DMV site 120. However, interface 220 is configured to process communications between credit card issuers (130-136) and main DMV site 120.

Input compiling process 230 performs operations on information that is received from either interface 210 or 220. That is, information that is sent from local DMV sites (110-116) through communications channel 140, is received at interface 210 and forwarded to input compiling process 230 for performing the necessary functions associated with features and principles of the present invention. Also, information sent from credit card issuers (130-136) through communications channel 150 is received at interface 220 and forwarded to input compiling process 230. Input compiling process 230 may include software or hardware configurations sufficient to handle the processing needs associated with credit validation operations, in accordance with features and principles of the present invention. Further description of the input compiling process will be given below with reference to FIGS. 4-6.

Output compiling process 240 performs operations on information that is to be transmitted from main DMV site 120. That is, information that is to be sent to local DMV sites (110-116) are processed in output compiling process 240, sent to interface 210 and transmitted to the appropriate DMV site through communications channel 140. In the same manner, information that is to be sent to credit card issuers (130-136) is processed in output compiling process 240, sent to interface 220 and transmitted to the appropriate credit card issuer through communications channel 150.

Compiling processes 230 and 240 may operate in various manners dependent upon the type of information that is being processed. For example, input compiling process 230 may receive standard DMV driver and/or vehicle information requests from interface 210, the operations performed may be directed to handling such requests. For example, input compiling process 230 may receive a request to collect credit history information for an applicant requesting a driver's license at local DMV site 110. After receiving the request, input compiling process 230 may access a database (not shown), that may be remote or local, that houses such information. The appropriate driver information is accessed and collected. Once collected, input compiling process may package the information in a format necessary for proper transmission, and sends the resultant information to the local DMV site that initiated the request.

On the other hand, input compiling process 230 may receive credit validation requests from interface 210 that originated from one of the local DMV sites (110-116). In this case, input compiling process 230 may invoke functionalities that handle these specific requests. These functionalities will be described further with reference to FIGS. 4-6.

FIG. 2B illustrates an exemplary block diagram of input compiling process 230 and output compiling process 240. As shown, input compiling process 230 includes credit validation engine 260 and communications link 266. Output compiling process includes credit validation engine 250 and communication link 256. Also shown in FIG. 2B are credit validation database 242 and communication link 270.

Input credit validation engine 260 performs all the necessary operations for handling incoming credit validation requests and responses. All credit validation requests sent from local DMV sites (110-116) are received at interface 210 and forwarded to input credit validation engine 260 through communication link 266. Once received, input credit validation engine 260 may determine whether a credit validation request is needed by checking a database of applicants stored in credit validation database 242. Input credit validation engine 260 sends the credit validation requests to output validation engine 250 through communication link 270 after flagging the request to indicate whether a credit card issuer (130-136) needs to be accessed or not. Input credit validation engine 260 may collect the credit validation requests and aggregate a plurality of the requests into a single package or message. This package is then sent to the output validation engine 250 for further processing as described in more detail below. Input credit validation engine 260 may send the requests to output credit validation engine 250 periodically or continuously, depending on the number of requests are at such a high volume. For example, input credit validation engine 260 may receive, at an average, 10 requests per minute. Accordingly, the credit validation packages may be sent to output credit card issuer 250 every minute as well. Of course, the manner by which input credit validation engine 260 receives and sends the credit validation requests may vary, based on the configuration of the main DMV site 120 and the local DMV sites (110-116). For instance, input credit validation engine 260 may receive, process and send each validation request as they are received. There are a variety of ways the requests may be processed and forwarded and the present invention is not limited to the examples set forth above.

Input credit validation engine 260 also receives response from credit card issuers (130-136). Credit validation responses are sent from credit card issuers (130-136) through communication link 150 to interface 220. From there, interface 220 forwards the responses to input credit validation engine 260 for processing. As done with the credit validation requests, input credit validation engine 260 configures the credit validation responses for processing at the output configuration engine 250. Also, input credit validation engine 260 may update credit validation database 242 using the information included in the credit validation responses.

Input credit validation engine 260 may include, but is not limited to, software and hardware configurations that have the ability to handle the high volume of information received from interfaces 210 and 220. The requests received from local DMV sites (110-116) may vary from site to site. Input credit validation engine 260 may include the necessary software and hardware to compensate for the various protocols and message configurations by which the local DMV sites communicate with the main DMV site 120. Input credit validation engine 260 ensures that the request received from the local DMV sites are configured in a format suitable for processing at the output credit validation engine 250. Furthermore, input credit validation engine 260 also configures the responses received from credit card issuers (130-136) in a format suitable for processing by the output credit validation engine 250. Description of how input credit validation engine 260 handles credit validation requests and responses will be described further with respect to FIGS. 4-6.

Output credit validation engine 250 performs all the necessary operations for sending credit validation requests to credit card issuers (130-136), as well as credit validation responses to local DMV sites (110-116). All credit validation requests sent from input credit validation engine 260 are received through communication link 270. Once received, output credit validation engine 250 may determine whether a credit validation request is needed based on flags set by input credit validation engine 260. Output credit validation engine 250 may collect the credit validation requests and aggregate a plurality of the requests into a single package or message. This package is then sent to the credit card issuers (130-136) through link 256 and interface 220. Output credit validation engine 250 may send the requests to credit card issuers (130-136) periodically or continuously, depending on how the requests are received from input credit validation engine 260. For example, output credit validation engine 250 may send a package of requests every minute to credit card issuers (130-136). Of course, the manner by which output credit validation engine 250 receives and sends the credit validation requests may vary, based on the configuration of the main DMV site 120 and the credit card issuers (130-136). For instance, output credit validation engine 250 may receive, process and send each validation request as they are received. The requests may be configured by output credit validation engine 250 into a format compatible with the protocol used by the credit card issuers (130-136). There are a variety of ways the requests may be processed and forwarded and the present invention is not limited to the examples set forth above.

Output credit validation engine 250 also processes and sends credit validation responses to the local DMV sites (110- 116). Credit validation responses are received from input credit validation engine 260 through communications link 270. As is done with the credit validation requests, output credit validation engine 250 configures the responses for use at the local DMV sites (110-116).

Output credit validation engine 250 may include, but is not limited to, software and hardware configurations that have the ability to handle the high volume of information received from input credit validation engine 260. Furthermore, output credit validation engine 250 may include the necessary software and hardware configurations to process, package and send validation requests and responses on communication link 256. Input credit validation engine 260 may include the necessary software and hardware to compensate for the various protocols and configurations by which the local DMV sites (110-116) and credit card issuers (130-136) communicate with the main DMV site 120. Output credit validation engine 250 ensures that the credit validation responses that are sent to the local DMV sites (110-116) are configured in a format suitable for processing at these sites. Furthermore, output credit validation engine 250 also configures the credit validation requests to a format suitable for processing by the credit card issuers (130-136). Description of how output credit validation engine 250 handles credit validation requests and responses will be described further with respect to FIGS. 4-6.

FIG. 2C illustrates an exemplary block diagram of a local DMV site 166 which the features and principles of the invention shown in system environment 105 may be implemented. As shown in FIG. 2C, local DMV site 166 includes a credit validation process 212, input compiling process 232, output compiling process 246 and interface 222. It should be noted that the features shown in FIG. 2C are related to the credit card features of the present invention. Local DMV site 166 may also include other well known features (not shown) that enable the site to process applications for driver's licenses.

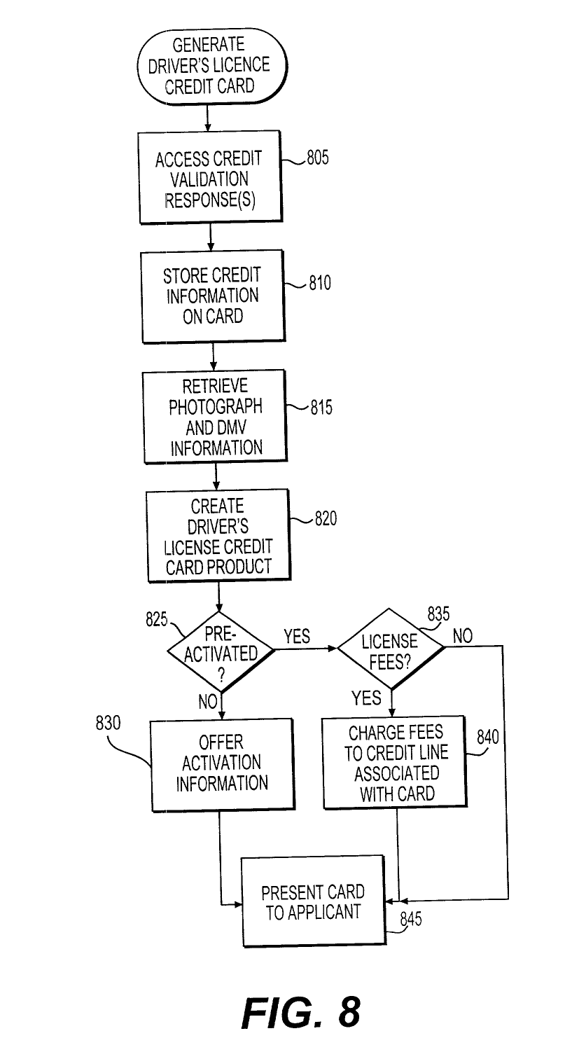

Credit validation process 212 may be software, hardware or a combination thereof, that processes applications for driver's license credit card products. Credit validation process 212 receives credit validation requests for selected applicants attempting to obtain a multi-purpose driver's license credit card product at local DMV site 166. The requests are sent to input compiling process 232 where they are processed for transmission to credit card issuers (170-176). Credit validation process 212 also receives results of the credit validation requests from output compiling process 246. Once received, the credit validation process 212 either authorizes local DMV site 166 to generate a credit card product with an applicant's driver's license. Description of the credit card driver's license production will be described in further detail with respect to FIG. 8.

Interface 222, may be a standard network interface that enables information to be sent from local DMV site 166 to network 190.

Input compiling process 232 performs operations on information that is received from either interface 222 or credit validation process 212. Input compiling process 232 may also be configured to send the received credit requests and credit responses, after processing, to output compiling process 246. Input compiling process 232 may include software or hardware configurations sufficient to handle the processing needs associated with DMV operations, in accordance with features and principles of the present invention. Further description of the input compiling process 232 will be given below with reference to FIGS. 4-6.

Output compiling process 246 performs operations on information that is received from input compiling process 232. That is, information that is to be sent from local DMV site 166 to network 190, is sent to interface 222 from output compiling process 246. Also, information such as responses to credit validation requests, are provided to credit validation process 212 from output compiling process 246. Further description of the output compiling process 246 will be given below with reference to FIGS. 4-6.

Compiling processes 232 and 246 may operate in various manners dependent upon the type of information that is being processed. For example, input compiling process 232 may receive standard DMV driver and/or vehicle information requests from a local DMV interface (not shown). Input compiling process 232 may be configured to send the DMV requests to main DMV site 180 through interface 222. Furthermore, output compiling process 246 may receive responses from main DMV site 180 through interface 222, and forward these responses to an appropriate DMV interface (not shown) for processing applications for driver's licenses at local DMV site 166.

The features described above with respect to FIG. 2C are exemplary and are not intended to be limiting. Any number of various configurations may be implemented at a local DMV site to process credit validation requests and responses in accordance with principles of the present invention.

FIG. 2D illustrates an exemplary block diagram of input compiling process 232 and output compiling process 246 in accordance with features and principles of the present invention. As shown, FIG. 2D includes input validation engine 232, output validation engine 246, input credit validation engine 262, output credit validation engine 252, communication links 258, 268 and 272, credit validation database 244.

Input credit validation engine 262 performs all the necessary operations for handling incoming credit validation requests and responses. All credit validation requests sent from credit validation process 212 are received at input credit validation engine 262. Once received, input credit validation engine 262 may determine whether a credit validation request is needed by checking a table of applicants stored in credit validation database 244. Input credit validation engine 262 sends the credit validation requests to output validation engine 252 through communication link 272 after flagging the request to indicate whether a credit card issuer (170-176) needs to be accessed or not. Input credit validation engine 262 may collect the credit validation requests and aggregate a plurality of the requests into a single package or message. This package is then sent to the output validation engine 252 for further processing. Input credit validation engine 262 may send the requests to output credit validation engine 252 periodically or continuously, depending on the number of requests. Of course, the manner by which input credit validation engine 262 receives and sends the credit validation requests may vary, based on the configuration of the local DMV site (160-166). There are a variety of ways the requests may be processed and forwarded and the present invention is not limited to the examples set forth above.

Input credit validation engine 262 may also receive responses from credit card issuers (170-176). Credit validation responses are sent from credit card issuers (170-176) through network 190 and communication links 152, 142 to interface 222. From there, interface 222 forwards the responses to input credit validation engine 262 for processing. As done with the credit validation requests, input credit validation engine 262 configures the responses for processing at the output configuration engine 252. Also, input credit validation engine 262 may update credit validation database 244 using the information included in the credit validation responses. The use of credit validation database 244 is optional. Local DMV site (160-166) may be configured such that all requests are processed remotely by a credit card issuer (170-176).

Input credit validation engine 262 may include, but is not limited to, software and hardware configurations that have the ability to handle the types of information received from credit validation process 212 and interface 222. Input credit validation engine 262 may include the necessary software and hardware to compensate for the various protocols and message configurations by which the local DMV site (160-166) communicates with the main DMV site 180 and credit card issuers (170-176). Input credit validation engine 262 ensures that the requests received by the local DMV site (160-166) are configured in a format suitable for processing at the output credit validation engine 252. Furthermore, input credit validation engine 262 also configures the responses received from credit card issuers (170-176) in a format suitable for processing by the output credit validation engine 252. Description of how input credit validation engine 262 handles credit validation requests and responses will be described further with respect to FIGS. 4-6.

Output credit validation engine 252 performs all the necessary operations for sending credit validation requests to credit card issuers (170-176), as well as credit validation responses to credit validation process 212. All credit validation requests sent from input credit validation engine 262 are received through communication link 272. Once received, output credit validation engine 252 may determine whether a credit validation request is needed based on flags set by input credit validation engine 262. Output credit validation engine 252 may collect the credit validation requests and aggregate a plurality of the requests into a single package or message. This package is then sent to the credit card issuers (170-176) through link 258 and interface 222. Output credit validation engine 252 may send the requests to credit card issuers (170-176) periodically or continuously, depending on how the requests are received from input credit validation engine 262. For example, output credit validation engine 252 may send a package of requests every minute to credit card issuers (170-176). Of course, the manner by which output credit validation engine 252 receives and sends the credit validation requests may vary, based on the configuration of local DMV site 166 and the credit card issuers (170-176). For instance, output credit validation engine 252 may receive, process and send each validation request as they are received. The requests may be configured by output credit validation engine 252 into a format compatible with the protocol used by the credit card issuers (170-176). There are a variety of ways the credit validation requests may be processed and forwarded and the present invention is not limited to the examples set forth above.

Output credit validation engine 252 also processes and sends credit validation responses to credit validation process 212. Credit validation responses are received from input credit validation engine 262 through communications link 270. As is done with the credit validation requests, output credit validation engine 252 configures the responses for use at the local DMV site 166.

Output credit validation engine 252 may include, but is not limited to, software and hardware configurations that have the ability to handle the types of information received from input credit validation information 262. Furthermore, output credit validation engine 252 may include the necessary software and hardware configurations to process, package and send validation requests and responses on communication link 142. Output credit validation engine 252 may include the necessary software and hardware to compensate for the various protocols and configurations by which the local DMV site 166 and credit card issuers (170-176) communicate. Output credit validation engine 252 also ensures that the credit validation responses that are sent to the local DMV site 166 are configured in a format suitable for processing at the sites. Furthermore, output credit validation engine 252 also configures the credit validation requests to a format suitable for processing by the credit card issuers (170-176). Description of how output credit validation engine 252 handles credit validation requests and responses will be described further with respect to FIGS. 4-6.

The configurations of elements described above with respect to FIGS. 2A-2D are merely exemplary. The features and principles of the present invention may be implemented in a variety of configurations other than that illustrated in FIGS. 2A-2D that enable a DMV site to generate multi-purpose driver's license credit cards based on credit validation responses sent from credit card issuers.

FIG. 3 illustrates an exemplary block diagram of one of the credit card issuers (130-136). As shown, credit card issuer 130 includes an interface 310, a decision engine 320 and a credit database 330. The credit card issuer 130 illustrated in FIG. 3 will be described in accordance with the features and principles of the invention shown in FIG. 1A. However, it should be noted that the operations of the credit card issuers (170-176) illustrated in FIG. 1B operate in a similar manner. Accordingly, the description of credit card issuer 130 below applies to the operations of the credit card issuers associated with system environment 105 illustrated in FIG. 1B.

Interface 310 may be a standard network interface that enables credit card issuer 130 to communicate with communications channel 150. In accordance with features and principles of the present invention, interface 310 receives credit card validation requests from channel 150. Interface 310 forwards the requests to decision engine 320. Additionally, interface 310 receives credit validation responses from decision engine 320 and transmits the responses to main DMV site 120 through communications channel 150.

Decision engine 320 may be a software, hardware or any combination thereof capable of processing credit validation requests in accordance with features and principles of the present invention. Decision engine 320 utilizes the information included within the requests for credit validation and information stored in credit database 330 to determine whether or not the requests should be granted. The information included in the credit validation requests may include, but are not limited to personal credit history information, address information, employment and income information, or any other type of information typically used by credit card issuers to determine credit worthiness. Decision engine 320 uses this information in each request to determine whether an applicant is worthy of obtaining a credit line with the credit card issuer 130. To evaluate and identify specific credit card customers, several factors maybe considered by the card issuer 130 and decision engine 320. Such factors may be based on credit information received from one or more credit information sources (i.e., sources that provide credit information to credit card issuer 130). Credit information may also be provided to credit card issuer 130 when customers respond to credit card offers provided by credit card issuer 130. Moreover, credit information may be requested by credit card issuer 130 through target customer group solicitations. Credit information may include credit history information and/or personal information (e.g., income, employment status, etc.) that are used when evaluating a customer's credit worthiness. Credit information sources may comprise commercial credit information source (such as TRW/Experian, Equifax and TransUnion or a similar commercial credit service bureau) and/or private credit information services. Credit information sources may also represent credit information that was provided by customers, such as when a customer applied for an existing credit card or the multi-purpose credit card product in accordance with features and principles of the present invention.

The credit information is analyzed to determine the credit worthiness or a level of risk associated with a potential cardholder. If an applicant is determined not be a credit risk, credit card issuer 130 may approve the customer to receive a credit line that is associated with a driver's license credit card.

Credit database 330 includes information associated with customers of credit card issuer 130. The information may include credit line accounts, balance information, credit history for each account, interest rate, etc. Decision engine 320 utilizes credit database 330 to obtain information associated with a customer of credit card issuer 130. Decision engine may also update credit database 330 with new customers based on credit validation requests received from the local DMV sites (110-116).

If a credit validation request is associated with an individual who is not a current customer of credit card issuer 130, decision engine may update bucket database when the individual is approved for a credit line. Decision engine 320 may update credit database 330 with credit line account information as well as personal information associated with the customer.

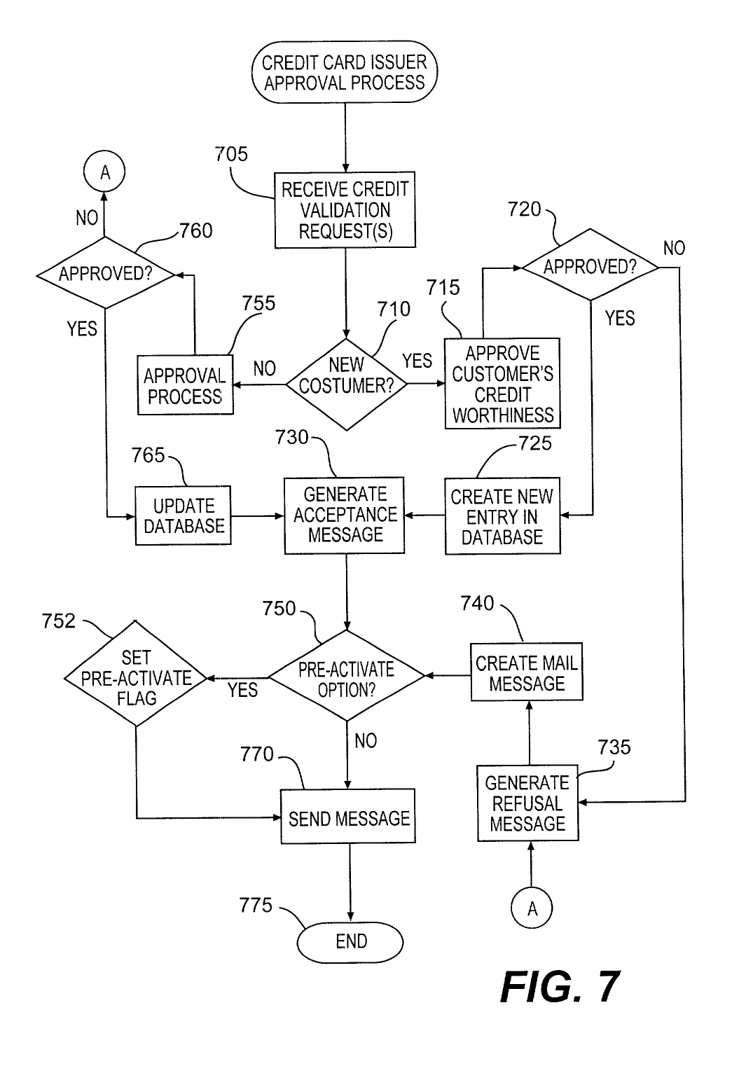

Decision engine 320 may also generate the validation response messages that are sent back to the local DMV sites (110-116). The response messages indicate to the local DMV site (110-116) whether or not an applicant has been approved of a credit line with credit card issuer 130. The response message may also include the necessary information associated with an approved credit line, such as interest rates, late fee charges, credit limit, cash advance balance, and any other credit line account information that credit card issuer 130 may decide to share with the applicant. Alternately, the credit validation responses may also include contact information from which the approved applicant may use to activate their generated driver's license credit card. Furthermore, the responses may include the necessary information to place on the multi-purpose card product when the local DMV sites (110-116) generate the driver's license credit card. This information may include the standard information stored on the magnetic stripe on credit card products, such as credit account number, credit balance, etc. Further description of the features associated with credit card issuer 130 will be described with reference to FIG. 7.

FIG. 4. illustrates an exemplary process associated with generating a driver's license credit card in accordance with features and principles of the present invention. According to one aspect of the invention, to obtain a driver's license credit card, an applicant visits a local DMV site (110-116) and applies for a driver's license (Step 400).

In another aspect of the present invention, an applicant may request pre-approval for a credit line with a credit card issuer prior to visiting a local DMV site (Step 405). For example, a customer may be solicited by credit card issuers (130-136) with driver's license credit card offers. These offers may also indicate to a individual that they are pre-approved for a certain amount of credit that may be used with a credit card driver's license. Conversely, credit card issuers 130-136 may solicit potential customers using conventional advertising mediums and techniques. For example, a potential customer may read about the driver's license credit card product in a newspaper advertisement or view a solicitation advertisement on television. The manner by which potential customers are solicited may vary and are not limited by the foregoing examples.

An applicant may perform the required pre-approval steps required by a credit card issuer (e.g., completing a credit application either telephonically or through conventional mail). Once the applicant is notified of their pre-approval by a credit card issuer (130-136), they may proceed to a local DMV site to apply for a driver's license (Step 400).

While at a local DMV site (110-116), the applicant may be required to provide personal information while filling out applications associated with obtaining a standard driver's license. This information may include: legal name, place of residence, social security number, employment status, etc. The applicant will be required to provide proof of their identity prior to receiving a driver's DMV personal. This item may be a social security card, a current driver's license, birth certificate, or any other type of identification that is accepted by the local DMV site. Once the applicant's identity is validated, the applicant may be required to perform selected tests, such as eye examinations, as mandated by the State where the DMV site sits.

At any point during the driver's license application process performed at the local DMV site (100-116), the applicant may be asked whether they wish to receive a multi-purpose driver's license credit card (Step 415). In one aspect of the invention, the local DMV site (100-116) may institute an underage preclusion feature that prevents applicants under a certain age (i.e., 18 years old) from receiving a request for a line of credit. This feature ensures applicants who not authorized to receive a line of credit from a credit card issuer based on their age do not obtain such credit at the local DMV sites (100-116).

Referring back to FIG. 4, if the applicant decides not to accept the offer (Step 415; NO), DMV processing continues as normal (Step 425). Here the DMV site determines whether the applicant is eligible to receive a driver's license based on the results of the tests performed by the applicant and other criteria such as the applicant's driver's history and restrictions imposed on the applicant by the State where the DMV sits. The DMV approval process may be performed in a variety of manners, and is not limited by the exemplary process described above. That is, the local DMV sites (110-116) may perform standard DMV procedures when determining whether an applicant is eligible to receive a driver's license.

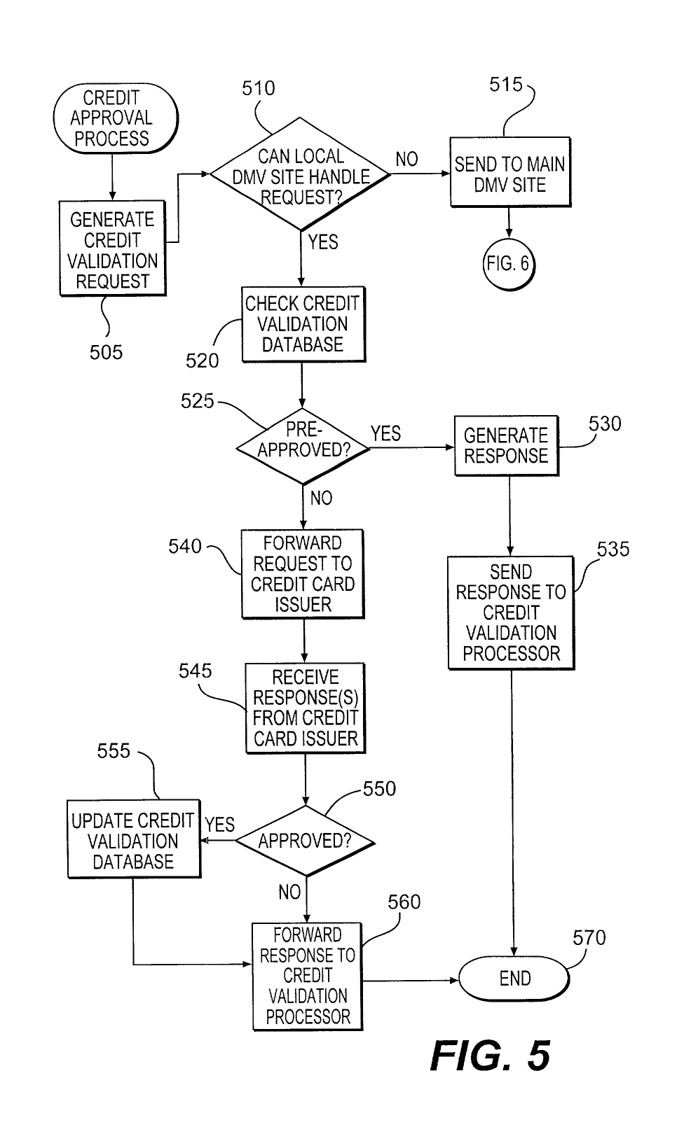

Referring back to Step 415, in the event an applicant does accept the opportunity to receive a driver's license credit card (Step 415; YES), the applicant may be required to complete a credit application at the local DMV site (110-116). The credit application may include standard credit-based questions associated with applications for credit cards. Such questions may be associated with credit history, employment status, residence history, etc. The credit applications may be completed using standard paper forms or through the use of paperless procedures such as computer entry. Once the credit application is properly completed by the applicant, the local DMV site (110-116) begins its credit approval process (Step 420) while other standard DMV procedures are taking place. This enables the present invention to allow both the DMV and credit approval process to be performed at the same time, thus minimizing the amount of time an applicant must wait for a decision and a driver's license. The credit approval process is described in further detail with reference to FIGS. 5-7.

In another aspect of the invention, the credit application may be waived if the applicant was pre-approved in Step 405. In this case, the local DMV site (110-116) would bypass the credit approval process (Step 420), and proceed directly to the DMV approval process. The applicant may indicate their pre-approval status to DMV personal at the local DMV site (110-116) while applying for a driver's license.

Once the DMV and credit approval processes have completed, the local DMV site (110-116) determines whether the license was approved based on the DMV approval process (Step 430). In the event the applicant is not eligible for a driver's license (Step 430; NO), the applicant is inherently unable to obtain a credit card driver's license as well. Accordingly, processing ends at Step 455. However, if the applicant is eligible for a driver's license (Step 430; YES), the local DMV site (100-116) determines whether applicant applied for a credit card (Step 435). If the applicant did not request a credit card in Step 415 (Step 435; NO), a standard driver's license is generated and issued to the applicant in accordance with normal procedures performed at the local DMV sites (Step 450). Also, if the applicant did request a credit card (Step 435; YES), but was not approved for a credit line from credit card issuers (Step 440; NO), the standard driver's license is generated and issued to the applicant (Step 450).

On the other hand, if the applicant was approved for a credit line from credit card issuers (130-136) (Step 440; YES), a credit card driver's license is generated by local DMV site (100-116) as described in FIG. 8 (Step 445) and subsequently processing ends at Step 455.

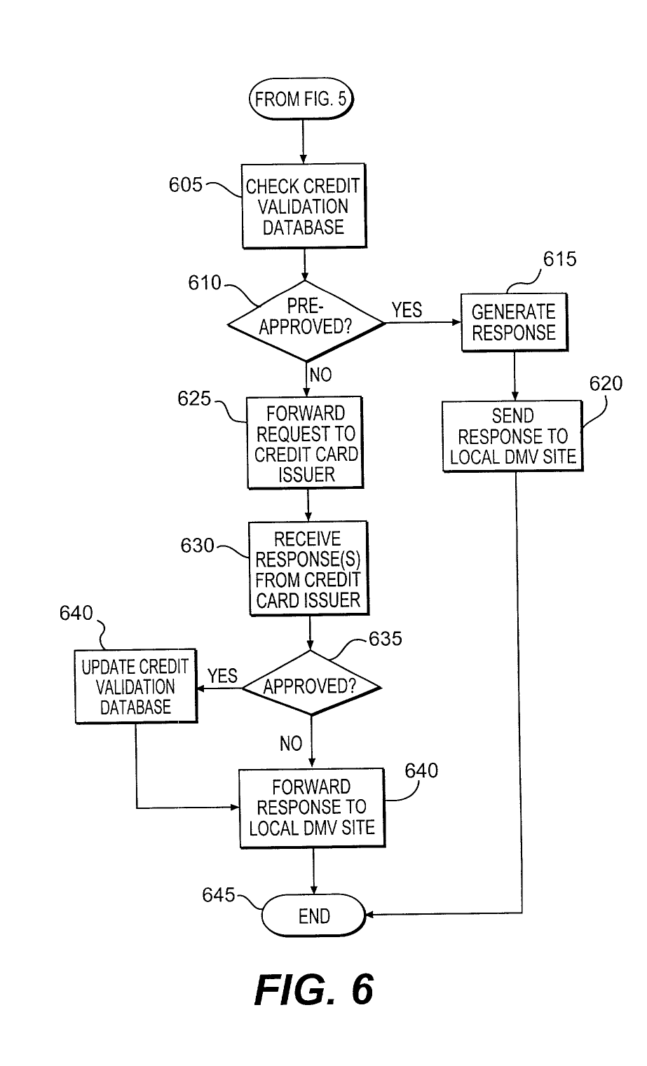

FIG. 5 illustrates an exemplary process associated with a credit approval process in accordance with features and principles of the present invention. The following description of the process described in FIG. 5 is associated with FIGS. 1A, 1B, 2C and 2D. According to one aspect of the invention, once an applicant decides to obtain a credit line for a driver's license, a credit validation request is generated by local DMV sites (110-116; 160-166) (Step 505). Once a validation request is generated, the local DMV site (110- 116; 160-166) determines whether they are capable of handling the request (Step 510). That is, if system environment 105 as illustrated in FIG. 1B is implemented, the local DMV sites (160-166) may handle the credit validation requests (Step 510; YES). On the other hand, if system environment 100 as illustrated in FIG. 1A is implemented, the local DMV sites (100-116) may not be able to handle the credit validation requests. (Step 510; NO). In either event, when the local DMV site does not handle the request(s), they are sent to main DMV site (120) for processing (Step 515). At this point, the credit approval process continues as illustrated in FIG. 6.

In the event system environment 105 has been implemented, and the local DMV sites (160-166) are configured to handle the validation request, the request is sent to input compiling process 232 by credit validation process 212. Once received, the request is forwarded to input credit validation engine 262. Validation engine 262 checks credit validation database 244 to determine whether the applicant already has pre-approved credit status (Step 520). If the applicant was previously approved by credit card issuers (170-176) during previous credit card driver's license procedures, this information would be stored in credit validation database 244.

In another aspect of the invention, credit card issuers (170-176) may provide pre-approval status information associated with the applicant in the event the applicant was pre-approved in Step 405. In this manner, local DMV site (160-166) may save DMV processing time by accessing the applicant's credit information locally, that was provided by credit card issuers (170-176).

In any event, if the applicant was pre-approved (Step 525; YES), input credit validation engine 262 may indicate this to output credit validation engine 252, via link 272. Input credit validation engine 262 may indicate pre-approval status by setting a flag within the request sent to output credit validation engine 252. Output credit validation engine 252 may recognize that the applicant has been pre-approved and generates a credit validation response message (Step 530). The response message may indicate that the applicant has been approved for a credit line to be added to their driver's license. The information may also include the data needed to be stored on the driver's license credit card's magnetic stripe, such as the credit line's credit limit, account information and personal identification information. Furthermore, the response may include credit card issuer's (170-176) terms and conditions information associated with the applicant's credit line that may be passed to the applicant. This information may include, but is not limited to, interest rate information, stipulations on late fees, overcharges and credit card related information that is normally passed to a customer who has obtained a new credit card. The credit information that is included in the response message generate d by output credit validation engine 252 may be provided by the credit card issuers (170-176) and stored in credit validation database 244. Output credit validation engine 252 may access this information in the event an applicant has been pre-approved.

Following its creation, the response message is passed to credit validation process 212 by output credit validation engine 252 via link 258 (Step 535). Once received, credit validation process 212 configures and passes the response message to the appropriate DMV entities for creating the multi-purpose credit card. The response message may be stored in a local memory for access by these entities. Details related to how the credit card driver's license product is created is described with reference to FIG. 8.

Referring back to Step 525, in the event the applicant was not pre-approved (Step 525; NO), input credit validation engine 262 may indicate this to output credit validation engine 252. Again, the indication may be in the form of a flag or any other manner that would enable output credit validation engine 262 to recognize that the applicant was not pre-approved. Once output credit validation engine 252 recognizes that the applicant was not pre-approved, it prepares the credit validation request that may have been sent by input validation engine 262 through link 272, for transmission on communication link 142 and network 190. Once properly prepared, the credit validation request is passed to an appropriate credit card issuer (170-176) through communication link 142, network 190 and communication link 152 (Step 540). Credit card issuer (170-176) performs its credit approval process, as illustrated in FIG. 7, and generates a credit validation response that indicates whether or not the applicant is approved for a credit line with the credit card issuer (170-176). The response may also include information associated with the credit line, such as credit limit, interest rate information, terms and conditions, account number, etc. The response may then be sent back to local DMV site (160-166) through communication link 152, network 190 and communication link 142.

The response is received at interface 222 and is passed to input compiling process 232 (Step 545). Within input compiling process 232, input credit validation engine 262 determines whether the response indicates approval or denial of a credit line for the applicant. In the event the applicant was approved (Step 550; YES), input credit validation engine 262 may update credit validation database 244 with data included in the response (Step 555). If not approved (Step 550; NO), no update takes place. Afterwards, the response is forwarded to output credit validation engine 252 along with an indication that the applicant has been approved for a credit line. Output credit validation engine 252 receives the information from input credit validation engine, and configures the response for processing by credit validation process 212. The response is then passed to credit validation engine 212 (Step 560), where the necessary DMV entities are notified of the applicant's approval. Credit validation process 212 may store the response information in a local memory for access by the local DMV site (160-166) when the credit card driver's license is generated. The generation of the multi-purpose credit card is further described in FIG. 8. Once the response message is received and processed by the credit validation process 212, the credit approval process ends (Step 570).

FIG. 6 illustrates an exemplary process associated with credit validation requests that are sent to the main DMV site 120 in system environment 100 for processing. The following description of the process described in FIG. 6 is associated with FIGS. 1A, 2A and 2B. According to one aspect of the invention, main DMV site 120 receives the credit validation request from the local DMV sites (100-116) (Step 600).

Interface 210 collects the request and forwards it to input compiling process 230 and subsequently input credit validation engine 260. Validation engine 260 checks credit validation database 242 to determine whether the applicant already has pre-approved credit status (Step 605). If the applicant was previously approved by credit card issuers (130-136) during previous credit card driver's license procedures, this information would be stored in credit validation database 242.

In another aspect of the invention, credit card issuers (130-136) may provide pre-approval status information associated with the applicant in the event the applicant was pre-approved in Step 405. In this manner, main DMV site 120 may save DMV processing time by access the applicant's credit information locally, that was provided by credit card issuers (130-136).

If the applicant was pre-approved (Step 610; YES), input credit validation engine 260 may indicate this to output credit validation engine 250, via link 270. Input credit validation engine 260 may indicate pre-approval status by sending a flag to output credit validation engine 250. Once such an indication is received, output credit validation engine 250 may recognize that the applicant has been pre-approved and generates a credit validation response message (Step 615). The response message may indicate that the applicant has been approved for a credit line to be associated with a driver's license credit card product. The information may also include the data needed to be stored on the driver's license credit card's magnetic stripe, such as the credit line's credit limit, account information and personal identification information. Furthermore, the response may include credit card issuer's (130-136) terms and conditions associated with the applicant's credit line that may be passed to the applicant. This information may include, but is not limited to, interest rate information, stipulations on late fees, overcharges and credit card related information that is normally passed to a customer who has obtained a new credit card.

Following its creation, the response message is passed to interface 210 by output credit validation engine 250 via link 256. Once received, interface 210 configures and passes the response message to the appropriate local DMV site (100-1 16) for creating the multi-purpose credit card. The response message may be stored in a local memory at the local DMV sites (110-116) for access by local DMV entities. Details related to how the credit card driver's license product is created is described with reference to FIG. 8.

Referring back to Step 610, in the event the applicant was not pre-approved (Step 610; NO), input credit validation engine 260 may indicate this to output credit validation engine 250. Again, the indication may be in the form of a flag or any other manner that would enable output credit validation engine 260 to recognize that the applicant was not pre-approved. Once output credit validation engine 250 recognizes that the applicant was not pre-approved, it prepares the credit validation request that may have been sent by input validation engine 260 through link 270, for transmission on communication link 150. Once properly prepared, the credit validation request is passed to an appropriate credit card issuer (130-136) through communication link 150 (Step 625). Credit card issuer (130-136) receives the request and performs a credit approval process, as illustrated in FIG. 7. After completion of the approval process, credit card issuer (130-136) may generate a credit validation response that indicates whether or not the applicant is approved for a credit line with the credit card issuer (130-136). The response may also include information associated with the credit line, such as credit limit, interest rate information, terms and conditions, account number, etc. The response may then be sent back to main DMV site 120 through communication link 150.

The response is subsequently received at interface 220 and is passed to input compiling process 230 (Step 630). Within input compiling process 230, input credit validation engine 260 determines whether the response indicates approval or denial of a credit line for the applicant. In the event the applicant was approved (Step 635; YES), input credit validation engine 260 may update credit validation database 242 with data included in the response (Step 640). Once the database 240 is updated, the response is forwarded to output credit validation engine 250 along with an indication that the applicant has been approved for a credit line. Output credit validation engine 250 receives the information from input credit validation engine, and configures the response for processing by interface 210. The response is then passed to interface 210 and then to the appropriate local DMV site (110-116) (Step 640), where the necessary DMV entities are notified of the applicant's approval. The response is also forwarded to the local DMV site (110-116) in the event the applicant was not approved (Step 635; NO). The local DMV site (110-116) may store the response information in a local memory for access by DMV entities that may generate the credit card driver's license. The generation of the multi-purpose credit card is further described in FIG. 8. Once the response message is received and processed by the local DMV site (110-116), the credit approval process ends (Step 645).

FIG. 7 illustrates an exemplary process associated with a credit approval process performed at the credit card issuers (130-136, 170-176), in accordance with features and principles of the present invention. The following description of the process described in FIG. 7 is associated with FIG. 3. Although FIG. 3 illustrates credit card issuer 130, the same operations are performed in the other credit card issuers (132-136, 170-176) illustrated in FIGS. 1A and 1B.

According to one aspect of the invention, the credit card issuer (130-136, 170-176) receives the credit validation requests from either the local DMV sites (160-166) or main DMV site (120, 180) at interface 310 (Step 705). Interface 310 collects the request and configures the information included within the request for processing by decision engine 320. Decision engine 320 receives the credit validation request information and then determines whether the applicant designated in the credit validation request is a new customer to the credit card issuer that has received the request (Step 710). In the event the applicant is a new customer (Step 710; YES), credit card issuer (130-136, 170-176) utilizes the credit information included in the request to determine the applicant's credit worthiness (Step 715). The credit worthiness check may involve the validation and analysis of a plurality of factors associated with the applicant. The factors may include, but are not limited to, credit history, employment status, yearly income and any other standard factors used by credit card issuers when determining credit worthiness. One feature of the invention that eliminates processing time at the credit card issuer's side is that the applicant's identity need not be validated. This is because the DMV sites have already authenticated the applicant's identity when the applicant applied for a driver's license. Accordingly, credit card issuer (130-136, 170-176) may perform credit worthiness checks immediately, without having to spend processing time validating the applicant's identity.

If credit card issuer (130-136, 170-176) determines that the applicant is worthy to receive a credit line (Step 720; YES), a local database 330 of credit card holders is updated to include the applicant (Step 725). The database 330 may include a plurality of standard credit line information for each customer of the credit card issuer, including account data, payment history, balance information, interest rate information, and any other form of credit data that may be used to track a customer's credit line. Once the database 330 is updated, decision engine 320 generates an acceptance message associated with the applicant's approval for a credit line with the credit card issuer (Step 730). The acceptance message may include, but is not limited to, an indicator that establishes that the applicant is approved for a credit line and credit line information (e.g., balance, interest rate, transaction limitations, account number, applicant's name, terms and condition information, etc.). Once the acceptance message is generated, processing is forwarded to Step 750.

However, in the event the applicant was not approved by credit card issuer (130-136, 170-176) (Step 720; NO), a refusal message is generated (Step 735). The refusal message may include, but is not limited to, an indication representing the applicant's inability to obtain a credit line from the credit card issuer. In addition to a refusal message, the credit card issuer (130-136, 170-176) may also generate a refusal message in the form of a letter that is to be mailed to the customer (Step 740). Once the refusal message(s) are generates, processing is forwarded to Step 750.

At step 750, decision engine 320 determines whether the request includes a pre-activation request (Step 750). This request may have been designated by the applicant as the credit card application was filled out at the local DMV site. This option would enable the applicant to receive a credit line that is already activated and ready for use once approved. The manner by which the applicant's decision to obtain a pre-activated credit line may be performed in a variety of ways and are not limited as described above. In one aspect of the invention, if the applicant has requested pre-activation of their approved credit line, a flag may be set to indicate this option (Step 752). The flag may be included in the validation response message generated by the decision engine 320 of the credit card issuer. If, on the other hand, the pre-activation option was not requested by the applicant, the pre-activate flag is not set (Step 750; NO). Afterwards, processing is forwarded to Step 770 for delivery of the response message to the local DMV sites. At step 770, the decision engine 320 packages the response message and sends it to interface 310 for delivery to the appropriate DMV site. Processing at the credit card issuer then ends (Step 775).

Referring back to Step 710, in the event the applicant was already a customer of the credit card issuer (130-136, 170-176), database 330 may include the applicant credit information already. In that case, decision engine 320 may only have to access the database 330 to determine the customer's credit worthiness (Step 755). If decision engine 320 determines that the applicant's credit history has changed, and thus preventing the acceptance of a credit line for the applicant (Step 760; No), processing is passed to Step 735 for the generation of a refusal message as described previously. However, if the applicant was approved for a credit line (Step 760; YES), the database 330 is updated with the appropriate information associated with the new credit line (Step 765). Afterwards, processing is passed to Step 730, where an acceptance message is created, as described previously.

FIG. 8 illustrates an exemplary process associated with the generation of a driver's license credit card at local DMV sites (100-116 and 130-136), in accordance with features and principles of the present invention. In one aspect of the invention, the credit validation responses are accessed, either from a local memory, or as they are received at the local DMV site (Step 805). The appropriate credit information associated with the applicant is separated from the response message and stored on a magnetic strip that is to be placed on the back of the driver's license (step 815). The appropriate information may include, account number, credit balance, credit line restrictions, expiration date, and the applicant's name and address information. In another aspect of the invention, if the driver's license is compatible with smart card technologies, the appropriate information would be loaded in the memory of the smart card.

Once the appropriate information that a standard credit card may use is stored on the magnetic strip, the driver's license information is placed on the card product that will host the magnetic strip. The card product may include standard driver's license data that is required by the State in which the local DMV site is located. Also, the card product may include State logo information, as well authenticating information, such as a photograph and digital stamps on the card for protection against fraud. In one aspect of the invention, the card product may also include the credit card account number, the credit card issuer's logo, as well as, for example, a VISA or MASTERCARD logo. The physical attributes of the driver's license credit card product is not limited to the examples above. Any number of characteristics and information may be placed on the product and the magnetic strip to enable the card product to operate as a valid driver's license and credit card.

Once the card product is generated, the local DMV site may determine whether the credit line was pre-activated by checking the response message for the pre-activation flag (Step 825). If the credit line was not pre-activated (Step 825; NO), the local DMV site may generate and provide to the applicant information associated with how the applicant may activate their credit line (Step 830). This information may include a telephone number or a web site to contact that enables the applicant to activate their credit card product. This information and the driver's license credit card product is then provided to the applicant for use (Step 845).

If on the other hand, the credit line was pre-activated (Step 825; YES), the local DMV site determines whether there were any processing fees associated with the DMV's generation of the driver's license credit card product (Step 835). If not (Step 835; NO), the card product is presented to the applicant for immediate use as a driver's license and a credit card (Step 845). However, if there were processing fees associated with the local DMV's services (Step 835; YES), these fees are automatically charged to the applicant's newly established credit line associated with the driver's license credit card product (Step 840). The applicant may be given a receipt of the charges, and the card product is presented to the applicant for immediate use as a driver's license and a credit card.

As described, the driver's license credit card product generated in accordance with features and principles of the present invention, enable an applicant and a local DMV site to charge DMV processing fees to the established credit line. The application of the credit line associated with the driver's license credit card product may not be limited to only DMV services. For instance, in addition to the standard goods and services the credit card product may be used to purchase, the applicant holding a driver's license credit card may utilize the card to pay for taxes associated with real estate or personal property. Also, one advantage to the credit card driver's license in accordance with principles and features of the present invention, is that a holder of the card product may not need to carry or use a separate form of identification when purchasing goods and services with the credit line associated with the driver's license credit card product.

In addition to the benefits to applicants, the DMV sites may also take advantage of the credit card issuer's services. In one aspect of the invention, credit card issuers may offer to front the costs of producing the driver's license credit cards at the local DMV sites in exchange for the opportunity to offer credit lines to applicants attempting to obtain driver's licenses. Furthermore, the pre-activation option associated with the credit line enable the DMV sites to receive immediate payment for the DMV services rendered.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

For example, in one embodiment of the invention, a credit card issuer may be associated with a governmental entity that issues lines of credit associated with particular types of purchases. For instance, such special lines of credit may be associated with the purchases of food items. Thus, a multi-purpose credit card may enable, for example, a government entity to manage the use of food stamps though the implementation of a credit card product that includes the holder's identification information, including photograph. The implementation of such types of credit card products may reduce the number of fraudulent purchases of food items by individuals who are not authorized to utilize subsidized food vouchers, such as food stamps.

Additionally, the above concept may be applied to a variety of other areas including, for example, smart cards for a various types of applications, company credit cards and airline based credit cards (for frequent flyer credits). Also, the site that generates identification card products may be associated with entities other than a DMV agency. That is, credit card issuers may form agreements with other types of governmental and non-governmental agencies that produce authorized forms of identification products. Thus, a line of credit offered by a credit card issuer may be applied to a variety of forms of identification products including, but not limited to, government agencies that distribute food vouchers to authorized applicants, passports, student identification cards, library identification cards, etc. In these alternate implementations, the entity producing the identification card product may charge fees for services, fines or goods, that have been received by an applicant receiving the card product, to a line of credit associated with the card product.

Furthermore, an agreement between DMV sites and credit card issuers may allow applicants to be notified of the credit card option offered by the card issuers when the DMV sends driver's license renewal notices to the applicants. Furthermore, the configurations illustrated in the figures are not meant to be limiting to the present invention. The system environments illustrated in the figures are one of many that may be implemented to perform the procedures described in FIGS. 4-8. For example, the input and output compiling processes of FIGS. 2A and 2C may be part of a single processing unit. Similarly, input and output credit validation units of FIGS. 2B and 2D may be part of a single validation engine. Also, the procedures illustrated in FIGS. 4-8 are also not intended to be limiting to the present invention. Any number of variations to the procedures shown in FIGS. 4-8 may be implemented to obtain a multi-purpose card product that function as both a valid driver's license and credit card.

What is claimed is:

1. A method of obtaining a credit card driver's license, comprising:
receiving a request from an applicant to obtain a credit card driver's license;
receiving credit information from the applicant;
transferring the credit information to a credit card issuer;
receiving an approval response indicating the applicant's ability to obtain a line of credit from the credit card issuer; and
creating a credit card driver's license product for the applicant based on the approval response, wherein the credit card driver's license product may be used as a license for operating a motor vehicle and as a credit card to purchase goods and services.

2. The method of claim 1, further comprising:
charging fees to a line of credit associated with the applicant's credit card driver's license, wherein the fees are associated with processing fees for obtaining a driver's license.

3. The method of claim 1, further comprising:
using the credit card driver's license product by the applicant to pay for goods and services at merchant sites that accept credit cards issued by the credit card issuer.

4. A method for obtaining a credit card driver's license, comprising:
receiving a request from an applicant to obtain a driver's license credit card product at a local driver's license issuing (“DMV”) site;
forwarding the request to a central DMV site;
determining whether the central DMV site is capable of processing the request;
transmitting the request to a credit card issuer if the central DMV site is not capable of processing the request;
transmitting a response from the central DMV site to the local DMV site if the central DMV site is capable of processing the request, wherein the response includes information indicating whether or not the applicant is approved to obtain a line of credit from the credit card issuer; and
creating, at the local DMV site, a credit card driver's license product for the applicant based on the response received from the central DMV site, wherein the credit card driver's license product may be used as a license for operating a motor vehicle and as a credit card to purchase goods and services.

5. The method of claim 4, wherein forwarding the request to a central DMV site includes:
determining whether the local DMV site is capable of processing the request; and
forwarding the request to a central DMV site based on the determination that the local DMV site is not capable of processing the request.

6. The method of claim 5, wherein determining whether the local DMV site is capable of processing the request includes:
checking a local DMV database to determine whether the applicant is approved for a credit line associated with the credit card issuer.

7. The method of claim 4, wherein determining whether the central DMV site is capable of processing the request includes:
checking a central DMV database to determine whether the applicant is approved for a credit line associated with the credit card issuer.

8. The method of claim 4, further comprising:
charging fees to a line of credit associated with the applicant's credit card driver's license product, wherein the fees are associated with processing fees for obtaining a driver's license.

9. The method of claim 4, further comprising:
using the credit card driver's license product by the applicant to pay for goods and services at merchant sites that accept credit cards issued by the credit card issuer.

10. The method of claim 4, wherein the response further includes information indicating that a credit line associated with the driver's license credit card product is activated, the method further comprising:
notifying the applicant that the credit line is activated.

11. A method of processing requests for a driver's license credit card that functions as a license to operate a motor vehicle and a credit card, including:
receiving a credit validation request associated with an applicant applying for a credit card driver's license at a driver's license issuing (“DMV”) site;
determining whether the applicant is approved for a line of credit with a credit card issuer based on information included within the credit validation request;
generating a credit validation response, wherein the credit validation response includes information indicating whether or not the applicant was approved for a line of credit with the credit card issuer; and
sending the credit validation response to the DMV site.

12. The method of claim 11, wherein generating the credit validation response includes:
determining that the applicant is approved for a line of credit with the credit card issuer;
generating credit information associated with the line of credit, wherein the credit information includes at least one of a credit limit, an account number associated with the line of credit, interest rate information associated with the line of credit, terms and conditions associated with the line of credit; and
including the credit information in the credit validation response.

13. The method of claim 11, wherein generating the credit validation response includes:
determining that the applicant is not approved for a line of credit associated with the credit card issuer; and
including in the credit validation response an indication that the applicant is not approved to obtain a line of credit from the credit card issuer.

14. A system for processing requests for a driver's license credit card product, comprising:
one or more local driver's license issuing (“DMV”) sites, each for receiving credit validation requests from one or more applicants applying for driver's license credit card products, sending the requests to a central DMV site, receiving credit validation responses from the central DMV site and for generating driver's license credit card products based on the credit validation responses, wherein the credit card driver's license product may be used as a license for operating a motor vehicle and as a credit card to purchase goods and services;
wherein the central DMV site receives the credit validation requests from the one or more local DMV sites, sends the credit validation requests to one or more credit card issuers, receives credit validation responses associated with the credit validation requests from the one or more credit card issuers, and sends the credit validation responses to the one or more local DMV sites; and
one or more credit card issuers for receiving credit validation requests from the central DMV site, determining whether each applicant associated with each credit validation request is eligible to obtain a line of credit from a respective credit card issuer, generating credit validation responses based on the determination and sending the credit validation responses to the central DMV site,
wherein the credit validation responses include a credit validation response that corresponds to each credit validation request that is associated with each applicant, and each credit validation response includes information indicating whether or not a respective applicant has been approved for a line of credit from the respective credit card issuer.

15. The system of claim 14, wherein the central DMV site is configured to process the credit validation requests received from the one or more local DMV sites by checking a central DMV database to determine whether each applicant associated with each credit validation request has been pre-approved to obtain a line of credit from the one or more credit card issuers.

16. The system of claim 14, wherein each one of the one or more local DMV sites are configured to charge fees to a line of credit associated with each applicant's credit card driver's license that obtained the credit card driver's license at a respective local DMV site, wherein the fees are associated with processing fees for obtaining a driver's license.

17. The system of claim 14, wherein the credit card driver's license product obtained by each applicant may be used to pay for goods and services at merchant sites that accept credit cards issued by the one or more credit card issuers.

18. A system for obtaining a credit card driver's license, comprising:
means for receiving a request from an applicant to obtain a credit card driver's license;
means for receiving credit information from the applicant;
means for transferring the credit information to a credit card issuer;
means for receiving an approval response indicating the applicant's ability to obtain a line of credit from the credit card issuer; and
means for creating a credit card driver's license product for the applicant based on the approval response, wherein the credit card driver's license product may be used as a license for operating a motor vehicle and as a credit card to purchase goods and services.

19. The system of claim 18, further comprising:
means for charging fees to a line of credit associated with the applicant's credit card driver's license, wherein the fees are associated with processing fees for obtaining a driver's license.

20. The system of claim 18, wherein the credit card driver's license product may be used by the applicant to pay for goods and services at merchant sites that accept credit cards issued by the credit card issuer.

21. A system for obtaining a credit card driver's license, comprising:
means for receiving a request from an applicant to obtain a driver's license credit card product at a local driver's license issuing (“DMV”) site;
means for forwarding the request to a central DMV site;
means for determining whether the central DMV site is capable of processing the request;
means for transmitting the request to a credit card issuer if the central DMV site is not capable of processing the request;
means for transmitting a response from the central DMV site to the local DMV site if the central DMV site is capable of processing the request, wherein the response includes information indicating whether or not the applicant is approved to obtain a line of credit from the credit card issuer; and
means for creating, at the local DMV site, a credit card driver's license product for the applicant based on the response received from the central DMV site, wherein the credit card driver's license product may be used as a license for operating a motor vehicle and as a credit card to purchase goods and services.

22. The system of claim 21, wherein the means for forwarding the request to a central DMV site includes:
means for determining whether the local DMV site is capable of processing the request; and
means for forwarding the request to a central DMV site based on the determination that the local DMV site is not capable of processing the request.

23. The system of claim 21, wherein the means for determining whether the local DMV site is capable of processing the request includes:
means for checking a local DMV database to determine whether the applicant is approved for a credit line associated with the credit card issuer.

24. The system of claim 21, wherein the means for determining whether the central DMV site is capable of processing the request includes:
means for checking a central DMV database to determine whether the applicant is approved for a credit line associated with the credit card issuer.

25. The system of claim 21, further comprising:
means for charging fees to a line of credit associated with the applicant's credit card driver's license product, wherein the fees are associated with processing fees for obtaining a driver's license.

26. The system of claim 21, wherein the response further includes information indicating that a credit line associated with the driver's license credit card product is activated, the system further comprising:
means for notifying the applicant that the credit line is activated.

27. A system for processing requests for a driver's license credit card that functions as a license to operate a motor vehicle and a credit card, including:
means for receiving a credit validation request associated with an applicant applying for a credit card driver's license at a driver's license issuing (“DMV”) site;
means for determining whether the applicant is approved for a line of credit with a credit card issuer based on information included within the credit validation request;
means for generating a credit validation response, wherein the credit validation response includes information indicating whether or not the applicant was approved for a line of credit with the credit card issuer; and
means for sending the credit validation response to the DMV site.

28. The system of claim 27, wherein the means for generating the credit validation response includes:
means for determining that the applicant is approved for a line of credit with the credit card issuer;
means for generating credit information associated with the line of credit, wherein the credit information includes at least one of a credit limit, an account number associated with the line of credit; interest rate information associated with the line of credit, terms and conditions associated with the line of credit; and
means for including the credit information in the credit validation response.

29. The system of claim 27, wherein the means for generating the credit validation response includes:
means for determining that the applicant is not approved for a line of credit associated with the credit card issuer; and
means for including in the credit validation response an indication that the applicant is not approved to obtain a line of credit from the credit card issuer.

30. A computer-readable medium including instructions for performing a method of obtaining a credit card driver's license, when executed by a processor, the method comprising:
receiving a request from an applicant to obtain a credit card driver's license;
receiving credit information from the applicant;
transferring the credit information to a credit card issuer;
receiving an approval response indicating the applicant's ability to obtain a line of credit from the credit card issuer; and
creating a credit card driver's license product for the applicant based on the approval response, wherein the credit card driver's license product may be used as a license for operating a motor vehicle and as a credit card to purchase goods and services.

31. The computer-readable medium of claim 30, wherein the method further comprises:
charging fees to a line of credit associated with the applicant's credit card driver's license, wherein the fees are associated with processing fees for obtaining a driver's license.

32. The computer-readable medium of claim 30, wherein the method further comprises:
using the credit card driver's license product by the applicant to pay for goods and services at merchant sites that accept credit cards issued by the credit card issuer.

33. A computer-readable medium including instructions for performing a method for obtaining a credit card driver's license, when executed by a processor, the method comprising:
receiving a request from an applicant to obtain a driver's license credit card product at a local driver's license issuing (“DMV”) site;
forwarding the request to a central DMV site;
determining whether the central DMV site is capable of processing the request;
transmitting the request to a credit card issuer if the central DMV site is not capable of processing the request;
transmitting a response from the central DMV site to the local DMV site if the central DMV site is capable of processing the request, wherein the response includes information indicating whether or not the applicant is approved to obtain a line of credit from the credit card issuer; and
creating, at the local DMV site, a credit card driver's license product for the applicant based on the response received from the central DMV site, wherein the credit card driver's license product may be used as a license for operating a motor vehicle and as a credit card to purchase goods and services.

34. The computer-readable medium of claim 33, wherein forwarding the request to a central DMV site includes:
determining whether the local DMV site is capable of processing the request; and
forwarding the request to a central DMV site based on the determination that the local DMV site is not capable of processing the request.

35. The computer-readable medium of claim 34, wherein determining whether the local DMV site is capable of processing the request includes:
checking a local DMV database to determine whether the applicant is approved for a credit line associated with the credit card issuer.

36. The computer-readable medium of claim 33, wherein determining whether the central DMV site is capable of processing the request includes:
checking a central DMV database to determine whether the applicant is approved for a credit line associated with the credit card issuer.

37. The computer-readable medium of claim 33, wherein the method further comprises:
charging fees to a line of credit associated with the applicant's credit card driver's license product, wherein the fees are associated with processing fees for obtaining a driver's license.

38. The computer-readable medium of claim 33, wherein the response further includes information indicating that a credit line associated with the driver's license credit card product is activated, the method further comprising:
notifying the applicant that the credit line is activated.

39. A computer-readable medium including instructions for performing a method, when executed by a processor, of processing requests for a driver's license credit card product that functions as a license to operate a motor vehicle and a credit card, the method comprising:
receiving a credit validation request associated with an applicant applying for a credit card driver's license at a driver's license issuing (“DMV”) site;
determining whether the applicant is approved for a line of credit associated with a credit card issuer based on information included within the credit validation request;
generating a credit validation response, wherein the credit validation response includes information indicating whether or not the applicant was approved for a line of credit with the credit card issuer; and
sending the credit validation response to the DMV site.

40. The computer-readable medium of claim 39, wherein generating the credit validation response includes:
determining that the applicant is approved for a line of credit with the credit card issuer;
generating credit information associated with the line of credit, wherein the credit information includes at least one of a credit limit, an account number associated with the line of credit; interest rate information associated with the line of credit, terms and conditions associated with the line of credit; and
including the credit information in the credit validation response.

41. The computer-readable medium of claim 39, wherein generating the credit validation response includes:
determining that the applicant is not approved for a line of credit associated with the credit card issuer; and
including in the credit validation response an indication that the applicant is not approved to obtain a line of credit from the credit card issuer.

42. A method of obtaining a multi-purpose credit card product, comprising:
receiving, at an identification card issuing entity, a request from an applicant to obtain a multi-purpose identification credit card;
receiving credit information from the applicant;
transferring the credit information to a credit card issuer;
receiving an approval response indicating the applicant's ability to obtain a line of credit from the credit card issuer; and
creating, at the identification card issuing entity, a multi-purpose identification credit card product for the applicant based on the approval response, wherein the multi-purpose identification credit card product may be used as a credit card to purchase goods and services and as an authorized identification card associated with the identification card issuing entity.

43. The method of claim 42, wherein the identification card issuing entity includes a government agency that distributes food vouchers to authorized applicants, and wherein the method farther includes:
using, by the applicant, the multi-purpose identification credit card product to purchase selected food items that are authorized for purchase by the government agency.

44. The method of claim 42, wherein the identification card issuing entity includes one of a government agency that distributes food vouchers to authorized applicants, a driver's license issuing site, an educational institution that provides student identification cards, a library and an authorized entity that provides passports, and wherein the method further comprises:
charging fees to a line of credit associated with the applicant's multi-purpose identification credit card product, wherein the fees are associated with the processing fees for obtaining an identification card at the identification card issuing entity.

45. A computer-readable medium, including instructions for performing a method, when executed by a processor, for obtaining a multi-purpose credit card product, the method comprising:
receiving, at an identification card issuing entity, a request from an applicant to obtain a multi-purpose identification credit card;
receiving credit information from the applicant;
transferring the credit information to a credit card issuer;
receiving an approval response indicating the applicant's ability to obtain a line of credit from the credit card issuer; and
creating, at the identification card issuing entity, a multi-purpose identification credit card product for the applicant based on the approval response, wherein the multi-purpose identification credit card product may be used as a credit card to purchase goods and services and as an authorized identification card associated with the identification card issuing entity.

46. The computer-readable medium of claim 45, wherein the identification card issuing entity includes a government agency that distributes food vouchers to authorized applicants, and wherein the method further includes:
using, by the applicant, the multi-purpose identification credit card product to purchase selected food items that are authorized for purchase by the government agency.

47. The computer-readable medium of claim 45, wherein the identification card issuing entity includes one of a government agency that distributes food vouchers to authorized applicants, a driver's license issuing site, an educational institution that provides student identification cards, a library and an authorized entity that provides passports, and wherein the method further comprises:
charging fees to a line of credit associated with the applicant's multi-purpose identification credit card product, wherein the fees are associated with the processing fees for obtaining an identification card at the identification card issuing entity.
